(19) United States
(12) Patent Application Publication
(10) Pub. No.: US 2026/0103976 A1
(43) Pub. Date: Apr. 16, 2026

(54) METHODS FOR ENHANCED DISPLAY OF EARTH MODELS FROM RESISTIVITY INVERSION

(71) Applicant: Baker Hughes Oilfield Operations LLC, Houston, TX (US)

(72) Inventors: Armando Vianna, Santa Catarina (BR); Florent Kelfoun, Pau (FR)

(21) Appl. No.: 18/913,565

(22) Filed: Oct. 11, 2024

Related U.S. Application Data
(60) Provisional application No. 63/590,081, filed on Oct. 13, 2023.

(51) Int. Cl. E21B 44/00; E21B 7/04; E21B 47/002; E21B 47/026

(52) U.S. Cl. CPC E21B 47/026; E21B 47/0025; E21B 2200/20

(57) ABSTRACT

A system for creating an enhanced parameter map of an earth formation. A sensor obtains parameter data from the earth formation. A processor obtains an initial parameter map along at least a portion of a borehole through the earth formation. The initial parameter map includes a distribution of values of a parameter of the earth formation. A profile of the parameter is selected from the initial parameter map. A region is selected within the selected profile and a location of a region boundary of the selected region is identified. A location of a region boundary of a neighboring region in a neighboring profile is identified and used to replace the selected region boundary. A location of the replaced region boundary is determined using the location of the region boundary of the neighboring region in the neighboring profile. An enhanced parameter map is displayed with the replaced region boundary.

### BACKGROUND

This application claims the benefit of an earlier filing date from U.S. Provisional Application Ser. No. 63/590,081, filed Oct. 13, 2023, the entire disclosure of which is incorporated herein by reference.

In the resource recovery and fluid sequestration industries, earth formations are tested or otherwise investigated for various properties, including a resistivity of an earth formation. Resistivity measurements are obtained using a sensor in a borehole and an inversion is performed on the resistivity measurements to create a resistivity map. The resistivity map can be used for geosteering to reach or avoid a particular target zone within the earth formation in the earth's subsurface. Noise in the measurement can affect the resolution of the resistivity map. Therefore, there is a need to create an enhanced map in which resistivity values and distance values are smoothened.

### SUMMARY

Disclosed herein is a method of creating an enhanced parameter map of an earth formation. An initial parameter map is obtained along at least a portion of a borehole through the earth formation, the initial parameter map comprising a distribution of values of a parameter of the earth formation. A profile of the parameter is selected from the initial parameter map, wherein the selected profile associates at least a portion of the values with a distance information from the borehole. A region is selected within the selected profile, the selected region having a selected region boundary. A location of the selected region boundary is identified. A location of a region boundary of a neighboring region in a neighboring profile is determined. The selected region boundary is replaced with a replaced region boundary, wherein a location of the replaced region boundary is determined by using the location of the region boundary of the neighboring region in the neighboring profile. The enhanced parameter map is displayed with the replaced region boundary.

Also disclosed herein is a system for creating an enhanced parameter map of an earth formation. The system includes a sensor for obtaining parameter data from the earth formation, and a processor. The processor is configured to obtain an initial parameter map along at least a portion of a borehole through the earth formation, the initial parameter map comprising a distribution of values of a parameter of the earth formation, select a selected profile of the parameter from the initial parameter map, wherein the selected profile associates at least a portion of the values with a distance information from the borehole, select a region within the selected profile, the selected region having a selected region boundary, identify a location of the selected region boundary, determine a location of a region boundary of a neighboring region in a neighboring profile, replace the selected region boundary with a replaced region boundary, wherein a location of the replaced region boundary is determined by using the location of the region boundary of the neighboring region in the neighboring profile, and display the enhanced parameter map with the replaced region boundary.

### BRIEF DESCRIPTION OF THE DRAWINGS

The following descriptions should not be considered limiting in any way. With reference to the accompanying drawings, like elements are numbered alike:

FIG. 1 shows a schematic diagram of a drilling system that includes a drill string having a drilling assembly conveyed in a borehole penetrating an earth formation;

FIG. 2 depicts an example of a resistivity map resulting from inversion of resistivity data obtained in a borehole, in a close-up view;

FIG. 3 shows a flowchart of a method for enhancing a resistivity map in an illustrative embodiment;

FIG. 4 is a marked resistivity map that illustrates a method for smoothing a region boundary of a resistive region;

FIG. 5 is a smoothed map including a replacement region boundary resulting from a smoothing process;

FIG. 6 shows a flowchart of a method for smoothing region boundaries, in an exemplary embodiment;

FIG. 7 is a smoothed resistivity map illustrating a method of replacing a resistivity of a selected resistive region with a new resistivity, in an illustrative embodiment; and

FIG. 8 shows a flowchart of a method for updating a resistivity of a selected resistive region.

### DETAILED DESCRIPTION

A detailed description of one or more embodiments of the disclosed apparatus and method are presented herein by way of exemplification and not limitation with reference to the Figures.

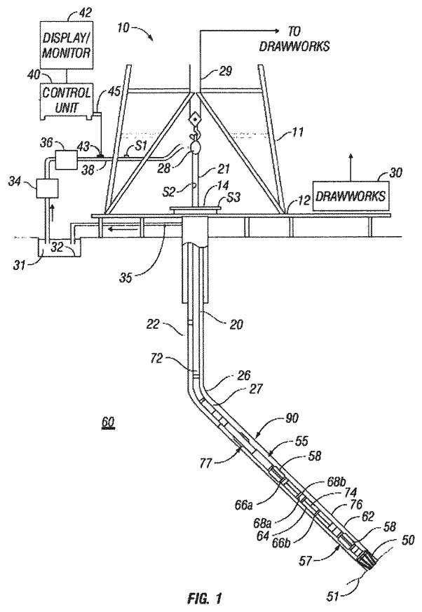

FIG. 1 shows a schematic diagram of a drilling system 10 that includes a drill string 20 having a drilling assembly 90, also referred to as a bottomhole assembly (BHA), conveyed in a borehole 26 penetrating an earth formation 60. The drilling system 10 includes a conventional derrick 11 erected on a floor 12 that supports a rotary table 14 that is rotated by a prime mover, such as an electric motor (not shown), at a desired rotational speed. The drill string 20 includes a drilling tubular, such as a drill pipe 22, extending downward from the rotary table 14 into the borehole 26. A drill bit 50, attached to the end of the drilling assembly 90, disintegrates the geological formations when it is rotated to drill the borehole 26. The drill string 20 is coupled to a drawworks 30 via a kelly joint 21, swivel 28 and line 29 through a pulley. During the drilling operations, the drawworks 30 is operated to control the weight on bit, which affects the rate of penetration. The operation of the drawworks 30 is well known in the art and is thus not described in detail herein.

The borehole 26 can be a deviated borehole and can also have a horizontal section. In a horizontal borehole, at least a portion of the borehole extends in a horizontal direction. In a borehole, a measured depth (MD) is a distance from a surface location (e.g., a floor 12 of derrick 11) along a length of the borehole. A distance along a vertical line toward the earth's surface is referred to as total vertical depth (TVD).

During drilling operations a drilling fluid 31 (also referred to as the “mud”) from a source or mud pit 32 is circulated under pressure through the drill string 20 by a mud pump 34. The drilling fluid 31 passes into the drill string 20 via a desurger 36, fluid line 38 and the kelly joint 21. The drilling fluid 31 is discharged at the borehole bottom 51 through an opening in the drill bit 50. The drilling fluid 31 circulates uphole through the annular space 27 between the drill string 20 and the borehole 26 and returns to the mud pit 32 via a return line 35. A sensor S1 in the fluid line 38 provides information about the fluid flow rate. A surface torque sensor S2 and a sensor S3 associated with the drill string 20 respectively provide information about the torque and the rotational speed of the drill string. Additionally, one or more sensors (not shown) associated with line 29 are used to provide the hook load of the drill string 20 and other desired parameters relating to the drilling of the borehole 26.

In some applications the drill bit 50 is rotated by only rotating the drill pipe 22. However, in other applications, a drilling motor (e.g., mud motor 55) disposed in the drilling assembly 90 is used to rotate the drill bit 50 and/or to superimpose or supplement the rotation of the drill string 20. In either case, the rate of penetration (ROP) of the drill bit 50 into the borehole 26 for a given earth formation 60 and a drilling assembly largely depends upon the weight on bit and the drill bit rotational speed. In one aspect of the embodiment of FIG. 1, the mud motor 55 is coupled to the drill bit 50 via a drive shaft (not shown) disposed in a bearing assembly 57. The mud motor 55 rotates the drill bit 50 when the drilling fluid 31 passes through the mud motor 55 under pressure. The bearing assembly 57 supports the radial and axial forces of the drill bit 50, the downthrust of the drilling motor and the reactive upward loading from the applied weight on bit. Stabilizers 58 coupled to the bearing assembly 57 and other suitable locations act as centralizers for the lowermost portion of the mud motor assembly and other such suitable locations.

Drilling assembly 90 also contains other sensors and devices or tools for providing a variety of formation evaluation parameter measurements relating to the earth formation 60 surrounding the borehole 26 and for drilling the borehole 26 along a desired path. Such devices may include a device for measuring the formation resistivity near and/or in front of the drill bit 50, a gamma ray device 76 for measuring the formation gamma ray intensity and devices for determining the inclination, azimuth and position of the drill string (e.g., inclinometer 74). A formation resistivity tool 64, made according to an embodiment described herein may be coupled at any suitable location, including above a lower kick-off subassembly 62, for estimating or determining the resistivity of the earth formation 60 near or in front of the drill bit 50 or at other suitable locations. In one embodiment, the formation resistivity tool 64 can include one or more electrodes. In another embodiment, the formation resistivity tool 64 can include a plurality of antennas including, for example, transmitters 66a or 66b or and receivers 68a or 68b. In FIG. 1, the transmitters 66a and 66b and the receivers 68a and 68b are illustrated as being part of the same module. It shall be understood, however, that in some instances, the transmitters and receivers may need to be separated by distances that span more than one module.

The inclinometer 74, such as an accelerometer, and the gamma ray device 76 may be suitably placed for respectively determining the inclination of the BHA and the formation gamma ray intensity. Any suitable inclinometer and gamma ray device may be utilized. In addition, an azimuth device (not shown), such as a magnetometer or a gyroscopic device, may be utilized to determine the drill string azimuth. Such devices are known in the art and therefore are not described in detail herein. In the above-described exemplary configuration, the mud motor 55 transfers power to the drill bit 50 via a hollow shaft that also enables the drilling fluid to pass from the mud motor 55 to the drill bit 50. In an alternative embodiment of the drill string 20, the mud motor 55 may be coupled below the formation resistivity tool 64 or at any other suitable place.

Other logging-while-drilling (LWD) devices (generally denoted herein by numeral 77), such as devices for measuring formation porosity, permeability, density, rock properties, fluid properties, etc. may be placed at suitable locations in the drilling assembly 90 for providing information useful for evaluating the subsurface earth formations along borehole 26. Such devices may include, but are not limited to, acoustic tools, nuclear tools, nuclear magnetic resonance tools and formation testing and sampling tools.

A surface control unit 40 receives signals from the downhole sensors and devices via a sensor 43 placed in the fluid line 38 as well as from sensors S1, S2, S3, hook load sensors and any other sensors used in the system and processes such signals according to programmed instructions provided to the surface control unit 40. The surface control unit 40 displays desired drilling parameters and other information on a display/monitor 42 for use by an operator at the rig site to control the drilling operations. The surface control unit 40 contains a computer, memory for storing data, computer programs, models and algorithms accessible to a processor in the computer, a recorder, such as any nonvolatile mass storage devices, like e.g. tape, hard disc drives, USB sticks, Solid State Disc or any suitable memory device known as state of the art, unit for recording data and other peripherals. The surface control unit 40 also may include simulation models for use by the computer to process data according to programmed instructions. The surface control unit 40 responds to user commands entered through a suitable device, such as a keyboard, computer mouse, joystick or any suitable manual input device known as state of the art. In various embodiments, the surface control unit 40 is adapted to control various operations of the drill string 20, which can include adjusting a drilling parameter, such as weight on bit, revolutions per minute, etc. The surface control unit 40 can also enhance a formation evaluation parameter map created from the formation evaluation parameter data obtained by one or more of the LWD devices 77, such as a resistivity map created from the formation resistivity data obtained by the resistivity tool 64 for presentation at the display/monitor 42, as disclosed herein.

The above-noted devices transmit data to a downhole telemetry system 72, which in turn transmits the received data uphole to the surface control unit 40. The downhole telemetry system 72 also receives signals and data from the surface control unit 40 and transmits such received signals and data to the appropriate downhole devices. In one aspect, a mud pulse telemetry system may be used to communicate data between the downhole sensors and devices and the surface equipment during drilling operations. A sensor 43 placed in the fluid line 38 detects the mud pulses responsive to the data transmitted by the downhole telemetry system 72. The sensor 43 generates electrical signals in response to the mud pressure variations and transmits such signals via a conductor 45 to the surface control unit 40. In other aspects, any other suitable telemetry system may be used for two-way data communication between the surface equipment and the drilling assembly 90, including but not limited to, an acoustic telemetry system, an electro-magnetic telemetry system, a wired telemetry system that may utilize repeaters in the drill string or the borehole 26 and a wired pipe. The wired pipe may be made up by joining drill pipe sections, wherein each pipe section includes a data communication link that runs along the pipe. The data connection between the pipe sections may be made by any suitable method, including but not limited to, hard electrical or optical connections and induction methods. In case a coiled-tubing is used as the drill pipe 22, the data communication link may be run along a side of the coiled-tubing.

FIG. 1 shows an embodiment for a drill string. It is understood however that the drill string can be replaced with any type of work string, such as a fluid sequestration string, completion string, production string, etc.

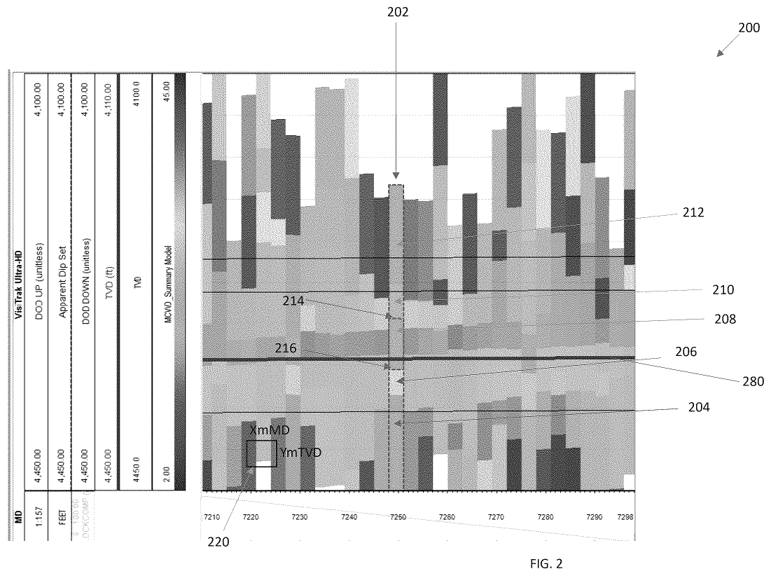

FIG. 2 depicts an example of an initial resistivity map 200 resulting from inversion of resistivity data obtained in a borehole (e.g., borehole 26 in FIG. 1), in a close-up view. The initial resistivity map 200 shows resistivity of an earth formation 60 surrounding the borehole 26, which is illustrated by line 280. The initial resistivity map 200 is shown for a horizontal borehole. Location information related to the extension along the borehole trajectory (e.g., measured depth (MD) or horizontal extension if the borehole 26 is oriented in a horizontal direction) is shown along the abscissa and a distance information to the borehole 26 or line 280 is shown along the ordinate axis. The distance information to the borehole 26 or line 280 may be a distance in meters or feet, etc., or a suitable scale from which the distance can be calculated. For example, in a horizontal borehole, the distance information to the borehole 26 can be the total vertical depth (TVD). The location information and the distance information together can define a location on any of the resistivity maps in FIGS. 2, 4, 5, and 7. The initial resistivity map 200 includes a plurality of one-dimensional profiles that are obtained at different measured depths within a borehole. The profiles are adjacent to each other along the axis of the borehole 26 or line 280 as shown in FIG. 2. Each profile extends along a direction perpendicular to line 280.

A profile associates resistivity values with the distance from the borehole 26 or line 280. A profile includes one or more resistive regions, which may correspond to different formation layers of the earth formation 60. A resistive region as used for the purpose of this disclosure is defined by one or more region boundaries and optionally by at least one resistivity value. For illustrative purposes, a selected profile 202 is shown and resistive regions 204, 206, 208, 210 and 212 are identified in the selected profile 202. Resistive regions within a profile are separated by region boundaries. A top region boundary 214 and a bottom region boundary 216 for resistive region 208 is shown for illustrative purposes.

The resistivity of a resistive region is indicated in the initial resistivity map 200 using an associated color. Each resistive region also has an associated inversion confidence (not shown) that indicates a confidence in the value of the resistivity of the resistive region. The inversion confidence indicates a confidence in a quality of the inversion. The associated inversion confidence can be applied in calculations for determining an enhanced resistivity map, as disclosed herein.

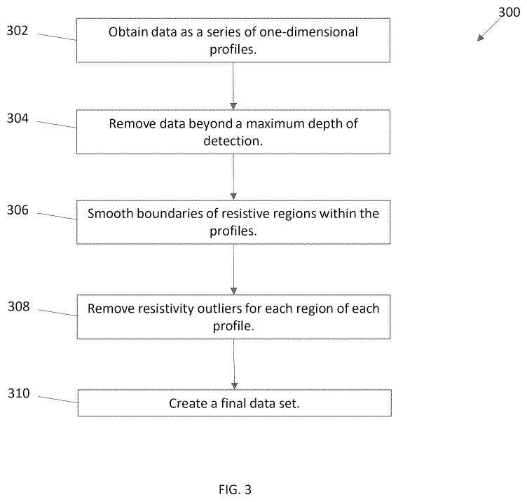

FIG. 3 shows a flowchart 300 of a method for enhancing a resistivity map in an illustrative embodiment. In box 302, an initial resistivity map is obtained. The initial resistivity map can be obtained from inversion of measurements obtained using a resistivity tool in a borehole (such as borehole 26 in FIG. 1) or through a simulation. The initial resistivity map includes a plurality of one-dimensional profiles, each extending perpendicular to line 280 in FIG. 2 and including one or more resistive regions.

In box 304, a maximum depth of detection (DoD) is selected. The depth of detection depends on the tool 64 and/or the measurement parameter (such as but not limited to measurement frequencies, distances of transmitters and receivers on the tool) and the environment around tool 64. The depth of detection is determined in a direction perpendicular of the tool 64 that is colinear with line 280 of the initial resistivity map in FIG. 2. Determination of the depth of detection for a particular environment and tool can be done by numeric simulation and/or lab investigations, for example. For each profile, data or resistive regions that are located at a distance greater than the DoD is removed from the initial resistivity map. For a resistive region for which a first part is within the DoD and a second part that is outside of the DoD, both the first part and the second part are removed, including that part that is within the DoD. Alternatively, only the second part is removed leading to a shortened region with a top region boundary at a distance to line 280 that corresponds to the DoD.

In box 306, the region boundaries of the resistive regions within each profile are smoothed using the methods disclosed herein. A moving window 220 can be passed through the initial resistivity map to select each resistive regions for smoothing. The moving window 220 has length Xm parallel to line 280 and and height Ym perpendicular to line 280 and can start at the left bottom of the initial resistivity map and be moved from left to right to select a profile and then moved from bottom to top to select the resistive regions within the selected profile. While moving window 220 is shown in FIG. 2 as a rectangular that is relatively small compared to the width of one or more of neighboring profiles, other shapes and sizes may advantageously be utilized. For example, moving window may be sized to include several of the neighboring profiles (e.g., 5 or more or even 10 or more) may be sized to include only portions of selected profile and/or neighboring profile or to include one or more complete profiles of the selected profile and/or the neighboring profiles. For a selected resistive region in a selected profile, the region boundaries are compared to neighboring region boundaries of neighboring profiles and either adjusted (e.g., replaced by different region boundaries, such as region boundaries with a distance to line 280 that correspond to the average, the minimum, or the maximum of all region boundaries within the moving window) or maintained, as disclosed herein.

In box 308, resistivity outliers are removed. For a selected resistive region in a selected profile, the resistivity is compared to the resistivities of nearest region boundaries of neighboring profiles and either adjusted or maintained, as disclosed herein.

In box 310, the enhanced resistivity map is created. Creating the enhanced resistivity map includes adding resistivity points in the corrected resistive regions. The resistivity points are placed at a measured depth of the resistive region or profile and extending perpendicular to line 280 from a bottom region boundary of the resistive region to a top region boundary of the resistivity region, having the resistivity of the region. Extra points can be added to the map to constrain the display to align with the DoD. A mesh may be formed with the points and the enhanced display may be formed from the mesh.

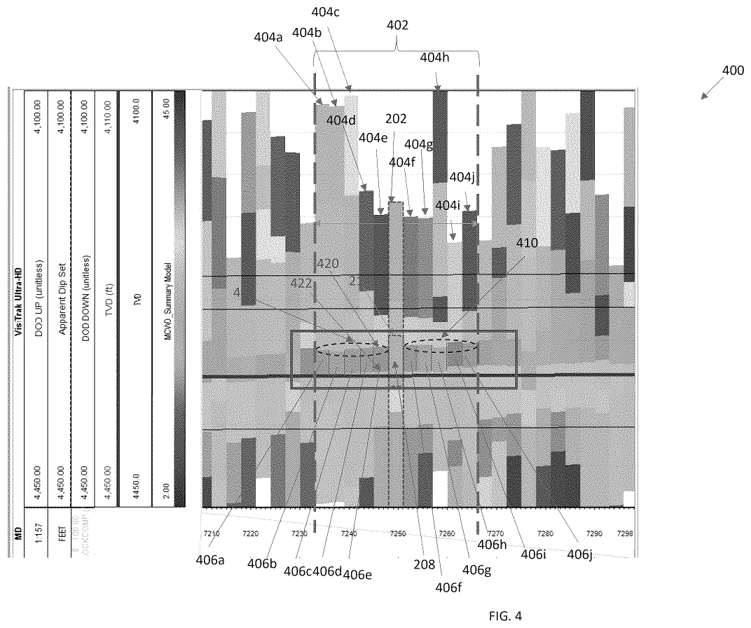

FIG. 4 is a marked resistivity map 400 that illustrates a method for smoothing a region boundary of a resistive region. The marked resistivity map 400 is built on the initial resistivity map 200 of FIG. 2. The marked resistivity map 400 includes a selected profile 202 and a selected resistive region 208 within the selected profile 202. Top region boundary 214 of the selected resistive region 208 is shown. A neighborhood 402 is defined with respect to the selected profile 202 including neighboring profiles (404a-404j) to the left and to the right of the selected profile 202 (neighboring profiles 404a-404e and neighboring profiles 404f-404j, respectively). The range of the neighborhood 402 can include any number of neighboring profiles. For illustrative purposes, the range in FIG. 4 includes five neighboring profiles (404a-404e) to the left of the selected profile 202 and five neighboring profiles (404f-404j) to the right of the selected profile 202.

To smooth the selected resistive region 208, neighboring profiles (404a-404j) are identified and neighboring resistive regions (406a-406j) are identified within each neighboring profile (404a-404j), respectively. A neighboring region (406a-406j) is a region at approximately a same distance to line 280 as the selected resistive region 208. Each neighboring region (406a-406j) has one or more associated region boundaries. For illustrative purposes, nearest region boundaries 408 are shown to the left of the selected resistive region 208 and nearest region boundaries 410 are shown to the right of the selected resistive region 208. For each of the neighboring regions (406a-406j), the region boundaries that are closest (have the least difference in distance to line 280) to the top region boundary 214 are identified and selected.

In one embodiment, a neighboring resistive region (such as neighboring region 406e) is identified. A first distance to line 280 is determined between the top region boundary 420 of the neighboring resistive region 406e and the top region boundary 214 of the selected resistive region 208. A second distance to line 280 is determined between the bottom region boundary 422 of the neighboring resistive region 406e and the top region boundary 214 of the selected resistive region 208. At least one of the top region boundary 420 of the neighboring resistive region 406e and the bottom region boundary 422 of the neighboring resistive region 406e having the smaller distance to line 280 is selected as a nearest region boundary 408, 410 of selected resistive region 208 in neighboring resistive region 406e. In another embodiment, each region boundary of the neighboring profiles (such as 406a-406j) is identified. The distance to line 280 of the top boundary 214 of selected resistive region 208 of selected profile 202 and the distance to line 280 of each identified region boundary of the neighboring profile 406e is determined for each region boundary of the neighboring profiles (such as 406a-406j). The region boundary in the neighboring profiles 406a-406j having the smallest distance to line 280 is selected as a nearest region boundary 408, 410 of selected resistive region 208 in neighboring profile 406e.

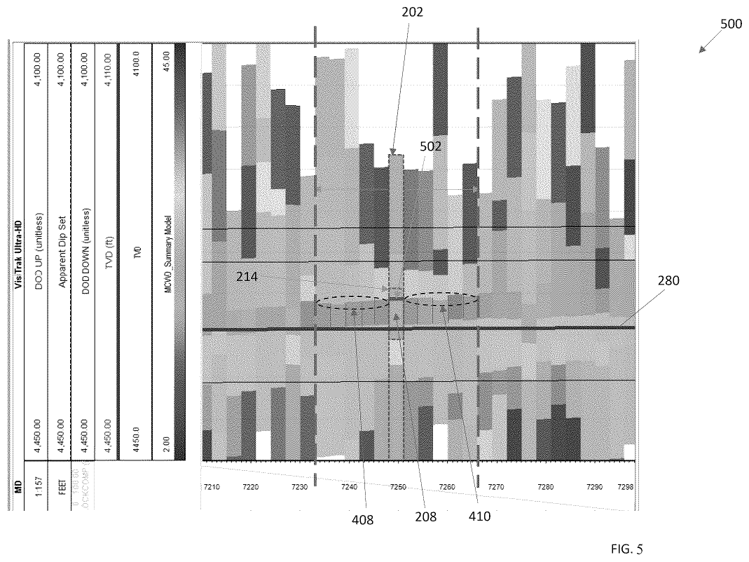

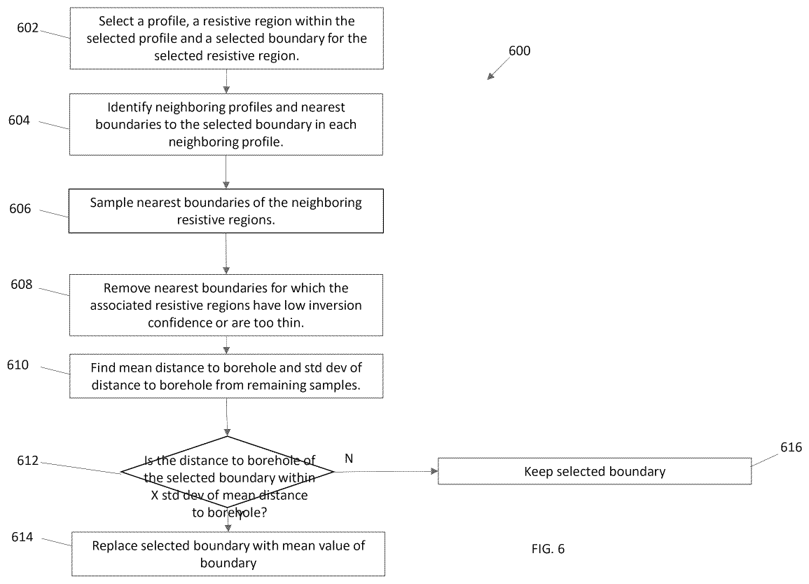

FIG. 5 is a smoothed map 500 including a replacement region boundary 502 resulting from a smoothing process. The smoothed map 500 is based on the initial resistivity map 200 of FIG. 2. In the smoothed map 500, the selected region boundary (e.g., top region boundary 214) is updated using the replacement region boundary 502. In various embodiments, updating the selected region boundary includes updating the original location of the selected region boundary (i.e., updating a distance to line 280 of the selected region boundary) or replacing the selected region boundary with the replacement region boundary 502. The selected region boundary is updated when the average of the neighboring region boundaries meets a criterion, as discussed below with respect to FIG. 6.

FIG. 6 shows a flowchart 600 of a method for smoothing region boundaries, in an exemplary embodiment. In box 602, a profile is selected, such as selected profile 202. A resistive region is selected within selected profile 202, such as selected resistive region 208, and a region boundary of the selected resistive region 208 is selected. For illustrative purposes, the selected region boundary is the top region boundary 214 of selected resistive region 208 in selected profile 202. In box 604, nearest region boundaries in neighboring profiles are identified. The nearest region boundary in a profile is the region boundary for which the distance to line 280 is closest to the distance to line 280 of the selected region boundary (e.g., top region boundary 214). In box 606, the nearest region boundaries of each neighboring profile are placed in a sample set. In box 608, a nearest region boundary is removed from the sample set when the resistive region associated with the nearest region boundary is either too thin or has an inversion confidence that is less than an inversion confidence threshold. In box 610, a mean location and a standard deviation are determined. The mean location is a mean distance to line 280 and the standard deviation is a standard deviation for the distances to line 280 of the nearest region boundaries that are remaining in the sample set.

In box 612, the mean distance to line 280 is compared to the distance to line 280 of the selected region boundary. If the difference between the mean distance to line 280 and the distance to line 280 of the selected region boundary is less than a distance confidence threshold (or distance to line 280 confidence threshold), the method proceeds to box 614. In box 614, the selected distance to line 280 is replaced by the mean distance to line 280 of two or more of the neighboring resistive regions in the neighboring profiles, effectively replacing the selected region boundary (e.g., top region boundary 214) with a smoothed region boundary (i.e., replacement region boundary 502).

Returning to box 612, if the difference between the mean distance to line 280 and the distance to line 280 of the selected region boundary is greater or equal to the selected distance confidence threshold (or distance to line 280 confidence threshold), the method proceeds to box 616. In box 616, the selected region boundary is maintained.

The selected distance to line 280 confidence threshold can be any amount. In an embodiment, the selected distance to line 280 confidence threshold is two standard deviations. A difference of less than the distance to line 280 confidence threshold can be indicative of a presence of small noise in the data and therefore results in smoothing (box 614). A difference that is greater than the distance to line 280 confidence threshold is more likely indicative of an actual difference between earth formations, thereby resulting in maintaining the current region boundary (box 616).

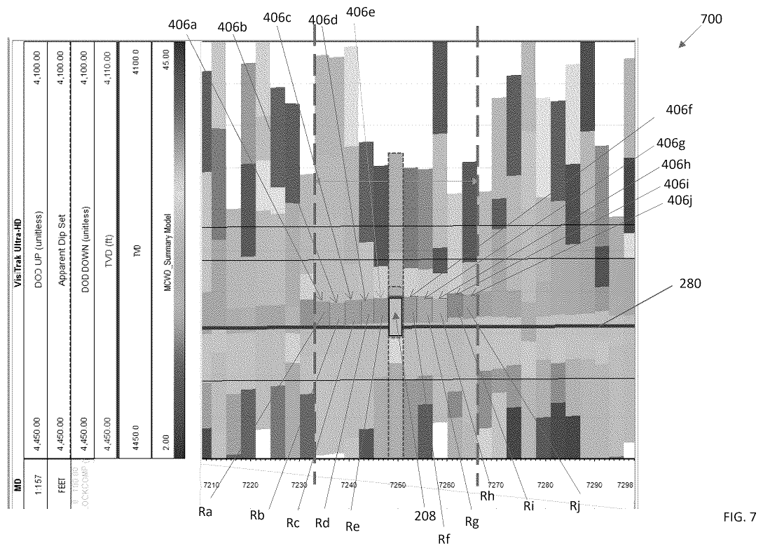

FIG. 7 is a smoothed resistivity map 700 illustrating a method of replacing a resistivity of a selected resistive region 208 with a new resistivity, in an illustrative embodiment. The new resistivity for the selected resistive region is selected from a resistivity of a neighboring resistivity region. The distance to line 280 is determine for a midpoint of the selected resistive region 208. The distance to line 280 of the midpoint is half of the sum of the distance to line 280 of the top region boundary and the distance to line 280 of the bottom region boundary. For each neighboring profile, the resistivity is sampled at the distance to line 280 at the midpoint of the neighboring profile. Resistivities at the midpoints of neighboring regions 406a-406e are labelled Rₐ-Rₑ, respectively Resistivities at the midpoints of neighboring regions 406f-406j are labelled R_{f}-Rⱼ, respectively These resistivities are placed into a sample set. The sample set is modified to remove those resistivities from neighboring regions that are either too thin or for which the inversion confidence is less than the inversion confidence threshold. A mean resistivity and a standard deviation of resistivity is determined for the resistivities remaining in the sample set. The mean resistivity is used to replace the resistivity of the selected resistive region 208 when the standard deviation meets a criterion.

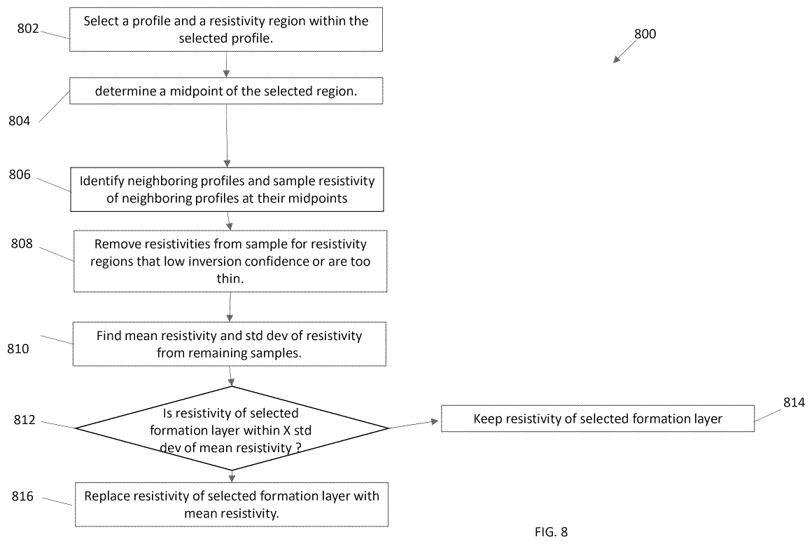

FIG. 8 shows a flowchart 800 of a method for updating a resistivity of a selected resistive region. In box 802, a profile is selected, (e.g., selected profile 202) and a resistive region (e.g., selected resistive region 208) is selected within the selected profile. In box 804, a distance to line 280 of a midpoint for the selected resistive region 208 is determined. The distance to line 280 of the midpoint is half of the sum of the distance to line 280 of the top region boundary and the distance to line 280 of the bottom region boundary. In box 806, neighboring profiles are identified. For each neighboring profile, resistivity is sampled at the midpoints of the neighboring profiles, with the midpoints determined using the distance to line 280 methods discussed with respect to box 804. The sampled resistivities are placed in a sample set. In box 808, the sample set is modified to remove any resistivities that are associated with neighboring regions that are either too thin or for which the inversion confidence is too small. In box 810, a mean resistivity value and a standard deviation of resistivity is calculated form the resistivities remaining in the sample set.

In box 812, the mean resistivity is compared to the resistivity of the selected resistive region 208. If the difference between the mean resistivity and the and the resistivity of the selected resistive region 208 is less than a selected resistivity confidence threshold, the method proceeds to box 814. In box 814, the selected resistivity is replaced by the mean resistivity. Returning to box 812, if the difference between the mean resistivity and the resistivity of the selected region boundary is greater or equal to the selected resistivity confidence threshold the method proceeds to box 816. In box 816, the resistivity of the selected resistive region 208 is maintained.

The selected resistivity confidence threshold can be any amount. In an embodiment, the selected resistivity confidence threshold is two standard deviations, as determined from the resistivity calculations. A difference of less than the resistivity confidence threshold can be indicative of a presence of small noise in the data. Thus, replacing the resistivity value removes this noise and smoothens the resistivity. A difference that is greater than the resistivity confidence threshold is more likely indicative of an actual difference between earth formations. Thus, the original resistivity is maintained.

Set forth below are some embodiments of the foregoing disclosure:

Embodiment 1. A method of creating an enhanced parameter map of an earth formation. The method includes obtaining an initial parameter map along at least a portion of a borehole through the earth formation, the initial parameter map comprising a distribution of values of a parameter of the earth formation, selecting a selected profile of the parameter from the initial parameter map, wherein the selected profile associates at least a portion of the values with a distance information from the borehole, selecting a region within the selected profile, the selected region having a selected region boundary, identifying a location of the selected region boundary, determining a location of a region boundary of a neighboring region in a neighboring profile, replacing the selected region boundary with a replaced region boundary, wherein a location of the replaced region boundary is determined by using the location of the region boundary of the neighboring region in the neighboring profile, and displaying the enhanced parameter map with the replaced region boundary.

Embodiment 2. The method of any prior embodiment, further comprising identifying an initial value of the parameter from the selected region, determining a replacement value of the parameter by using a neighboring value of the parameter from the neighboring region in the neighboring profile, replacing the initial value of the parameter from the selected region with the replacement value of the parameter, and displaying the enhanced parameter map with the replacement value of the parameter.

Embodiment 3. The method of any prior embodiment, wherein replacing the initial value of the parameter from the selected region further comprises replacing the initial value of the parameter from the selected region with the replacement value of the parameter only if a difference in at least one of: (i) the initial value of the parameter from the selected region and the replacement value of the parameter; and (ii) the initial value of the parameter from the selected region and the neighboring value of the parameter from the neighboring region in the neighboring profile is within of a parameter confidence threshold.

Embodiment 4. The method of any prior embodiment, further comprising selecting the region using a moving window that moves through the initial parameter map.

Embodiment 5. The method of any prior embodiment, wherein replacing the selected region boundary further comprises replacing the selected region boundary with the replaced region boundary only if a difference in at least one of: (i) the location of the selected region boundary and the location of the region boundary of the neighboring region in the neighboring profile; and (ii) the location of the selected region boundary and the location of the replaced region boundary is within a distance confidence threshold.

Embodiment 6. The method of any prior embodiment, wherein the neighboring region is a first neighboring region and the neighboring profile is a first neighboring profile, the method further comprising: determining a location of a region boundary of a second neighboring region in a second neighboring profile, wherein the location of the replaced region boundary is determined by using the location of the region boundary of the second neighboring region in the second neighboring profile.

Embodiment 7. The method of any prior embodiment, wherein the selected profile and the neighboring profile are separated by at least one separating profile of the parameter, wherein the separating profile associates at least a separating profile portion of the values with a separating profile distance information from the borehole.

Embodiment 8. The method of any prior embodiment, wherein the values of the parameter are measured by a measurement tool in the borehole, further comprising defining a depth of detection of the measurement tool and removing at least one of the values of the parameter in the initial parameter map based on a comparison of the distance information of the at least one removed value of the parameter and the depth of detection.

Embodiment 9. The method of any prior embodiment, wherein the neighboring profile is calculated by a numeric simulation and further comprising at least one of: (i) selecting the neighboring profile based on a confidence parameter of the numeric simulation; and (ii) selecting the neighboring region based on a thickness of the neighboring region.

Embodiment 10. The method of any prior embodiment, further comprising steering a drilling assembly through the borehole using the displayed enhanced parameter map.

Embodiment 11. A system for creating an enhanced parameter map of an earth formation. The system includes a sensor for obtaining parameter data from the earth formation, and a processor. The processor is configured to obtain an initial parameter map along at least a portion of a borehole through the earth formation, the initial parameter map comprising a distribution of values of a parameter of the earth formation, select a selected profile of the parameter from the initial parameter map, wherein the selected profile associates at least a portion of the values with a distance information from the borehole, select a region within the selected profile, the selected region having a selected region boundary, identify a location of the selected region boundary, determine a location of a region boundary of a neighboring region in a neighboring profile, replace the selected region boundary with a replaced region boundary, wherein a location of the replaced region boundary is determined by using the location of the region boundary of the neighboring region in the neighboring profile, and display the enhanced parameter map with the replaced region boundary.

Embodiment 12. The method of any prior embodiment, wherein the processor is further configured to identify an initial value of the parameter from the selected region, determine a replacement value of the parameter by using a neighboring value of the parameter from the neighboring region in the neighboring profile, replace the initial value of the parameter from the selected region with the replacement value of the parameter, and display the enhanced parameter map with the replacement value of the parameter.

Embodiment 13. The method of any prior embodiment, wherein the processor is further configured to replace the initial value of the parameter from the selected region by replacing the initial value of the parameter from the selected region with the replacement value of the parameter only if a difference in at least one of: (i) the initial value of the parameter from the selected region and the replacement value of the parameter; and (i) the initial value of the parameter from the selected region and the neighboring value of the parameter from the neighboring region in the neighboring profile is within of a parameter confidence threshold.

Embodiment 14. The method of any prior embodiment, wherein the processor is further configured to select the region using a moving window that moves through the initial parameter map.

Embodiment 15. The method of any prior embodiment, wherein the processor is further configured to replace the selected region boundary by replacing the selected region boundary with the replaced region boundary only if a difference in at least one of: (i) the location of the selected region boundary and the location of the region boundary of the neighboring region in the neighboring profile; and (ii) the location of the selected region boundary and the location of the replaced region boundary is within a distance confidence threshold.

Embodiment 16. The method of any prior embodiment, wherein the neighboring region is a first neighboring region and the neighboring profile is a first neighboring profile and the processor is further configured to determine a location of a region boundary of a second neighboring region in a second neighboring profile, wherein the location of the replaced region boundary is determined by using the location of the region boundary of the second neighboring region in the second neighboring profile.

Embodiment 17. The method of any prior embodiment, wherein the selected profile and the neighboring profile are separated by at least one separating profile of the parameter, wherein the separating profile associates at least a separating profile portion of the values with a separating profile distance information from the borehole.

Embodiment 18. The method of any prior embodiment, wherein the values of the parameter are measured by a measurement tool in the borehole and the processor is further configured to define a depth of detection of the measurement tool and remove at least one of the values of the parameter in the initial parameter map based on a comparison of the distance information of the at least one removed value of the parameter and the depth of detection.

Embodiment 19. The method of any prior embodiment, wherein the neighboring profile is calculated by a numeric simulation and the processor is further configured to perform at least one of: (i) selecting the neighboring profile based on a confidence parameter of the numeric simulation; and (ii) selecting the neighboring region based on a thickness of the neighboring region.

Embodiment 20. The method of any prior embodiment, wherein the processor is further configured to steer a drilling assembly through the borehole using the displayed enhanced parameter map.

The use of the terms “a” and “an” and “the” and similar referents in the context of describing the invention (especially in the context of the following claims) are to be construed to cover both the singular and the plural, unless otherwise indicated herein or clearly contradicted by context. Further, it should be noted that the terms “first,” “second,” and the like herein do not denote any order, quantity, or importance, but rather are used to distinguish one element from another. The terms “about”, “substantially” and “generally” are intended to include the degree of error associated with measurement of the particular quantity based upon the equipment available at the time of filing the application. For example, “about” and/or “substantially” and/or “generally” can include a range of ±8% of a given value.

The teachings of the present disclosure may be used in a variety of well operations. These operations may involve using one or more treatment agents to treat an earth formation, the fluids resident in an earth formation, a borehole, and/or equipment in the borehole, such as production tubing. The treatment agents may be in the form of liquids, gases, solids, semi-solids, and mixtures thereof. Illustrative treatment agents include, but are not limited to, fracturing fluids, acids, steam, water, brine, anti-corrosion agents, cement, permeability modifiers, drilling muds, emulsifiers, demulsifiers, tracers, flow improvers etc. Illustrative well operations include, but are not limited to, hydraulic fracturing, stimulation, tracer injection, cleaning, acidizing, steam injection, water flooding, cementing, etc.

While the invention has been described with reference to an exemplary embodiment or embodiments, it will be understood by those skilled in the art that various changes may be made and equivalents may be substituted for elements thereof without departing from the scope of the invention. For example, while the invention has been described with reference to resistivity (resistivity maps, resistivity measurements, resistivity sensors, etc.), it will be understood by those skilled in the art that the same teachings can be applied to other formation evaluation parameters (for example, parameters measured by other LWD devices). In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the claims. Also, in the drawings and the description, there have been disclosed exemplary embodiments of the invention and, although specific terms may have been employed, they are unless otherwise stated used in a generic and descriptive sense only and not for purposes of limitation, the scope of the invention therefore not being so limited.

What is claimed is:

1. A method of creating an enhanced parameter map of an earth formation, comprising:
obtaining an initial parameter map along at least a portion of a borehole through the earth formation, the initial parameter map comprising a distribution of values of a parameter of the earth formation;
selecting a selected profile of the parameter from the initial parameter map, wherein the selected profile associates at least a portion of the values with a distance information from the borehole;
selecting a region within the selected profile, the selected region having a selected region boundary;
identifying a location of the selected region boundary;
determining a location of a region boundary of a neighboring region in a neighboring profile;
replacing the selected region boundary with a replaced region boundary, wherein a location of the replaced region boundary is determined by using the location of the region boundary of the neighboring region in the neighboring profile; and
displaying the enhanced parameter map with the replaced region boundary.

2. The method of claim 1, further comprising:
identifying an initial value of the parameter from the selected region;
determining a replacement value of the parameter by using a neighboring value of the parameter from the neighboring region in the neighboring profile;
replacing the initial value of the parameter from the selected region with the replacement value of the parameter; and
displaying the enhanced parameter map with the replacement value of the parameter.

3. The method of claim 2, wherein replacing the initial value of the parameter from the selected region further comprises replacing the initial value of the parameter from the selected region with the replacement value of the parameter only if a difference in at least one of: (i) the initial value of the parameter from the selected region and the replacement value of the parameter; and (ii) the initial value of the parameter from the selected region and the neighboring value of the parameter from the neighboring region in the neighboring profile is within of a parameter confidence threshold.

4. The method of claim 3, further comprising selecting the region using a moving window that moves through the initial parameter map.

5. The method of claim 1, wherein replacing the selected region boundary further comprises replacing the selected region boundary with the replaced region boundary only if a difference in at least one of: (i) the location of the selected region boundary and the location of the region boundary of the neighboring region in the neighboring profile; and (ii) the location of the selected region boundary and the location of the replaced region boundary is within a distance confidence threshold.

6. The method of claim 1, wherein the neighboring region is a first neighboring region and the neighboring profile is a first neighboring profile, the method further comprising: determining a location of a region boundary of a second neighboring region in a second neighboring profile, wherein the location of the replaced region boundary is determined by using the location of the region boundary of the second neighboring region in the second neighboring profile.

7. The method of claim 1, wherein the selected profile and the neighboring profile are separated by at least one separating profile of the parameter, wherein the separating profile associates at least a separating profile portion of the values with a separating profile distance information from the borehole.

8. The method of claim 1, wherein the values of the parameter are measured by a measurement tool in the borehole, further comprising defining a depth of detection of the measurement tool and removing at least one of the values of the parameter in the initial parameter map based on a comparison of the distance information of the at least one removed value of the parameter and the depth of detection.

9. The method of claim 1, wherein the neighboring profile is calculated by a numeric simulation and further comprising at least one of: (i) selecting the neighboring profile based on a confidence parameter of the numeric simulation; and (ii) selecting the neighboring region based on a thickness of the neighboring region.

10. The method of claim 1, further comprising steering a drilling assembly through the borehole using the displayed enhanced parameter map.

11. A system for creating an enhanced parameter map of an earth formation, comprising:
a sensor for obtaining parameter data from the earth formation;
a processor configured to:
obtain an initial parameter map along at least a portion of a borehole through the earth formation, the initial parameter map comprising a distribution of values of a parameter of the earth formation;
select a selected profile of the parameter from the initial parameter map, wherein the selected profile associates at least a portion of the values with a distance information from the borehole;
select a region within the selected profile, the selected region having a selected region boundary;
identify a location of the selected region boundary;
determine a location of a region boundary of a neighboring region in a neighboring profile;
replace the selected region boundary with a replaced region boundary, wherein a location of the replaced region boundary is determined by using the location of the region boundary of the neighboring region in the neighboring profile; and
display the enhanced parameter map with the replaced region boundary.

12. The system of claim 11, wherein the processor is further configured to:
identify an initial value of the parameter from the selected region;
determine a replacement value of the parameter by using a neighboring value of the parameter from the neighboring region in the neighboring profile;
replace the initial value of the parameter from the selected region with the replacement value of the parameter; and
display the enhanced parameter map with the replacement value of the parameter.

13. The system of claim 12, wherein the processor is further configured to replace the initial value of the parameter from the selected region by replacing the initial value of the parameter from the selected region with the replacement value of the parameter only if a difference in at least one of: (i) the initial value of the parameter from the selected region and the replacement value of the parameter; and (i) the initial value of the parameter from the selected region and the neighboring value of the parameter from the neighboring region in the neighboring profile is within of a parameter confidence threshold.

14. The system of claim 13, wherein the processor is further configured to select the region using a moving window that moves through the initial parameter map.

15. The system of claim 11, wherein the processor is further configured to replace the selected region boundary by replacing the selected region boundary with the replaced region boundary only if a difference in at least one of: (i) the location of the selected region boundary and the location of the region boundary of the neighboring region in the neighboring profile; and (ii) the location of the selected region boundary and the location of the replaced region boundary is within a distance confidence threshold.

16. The system of claim 11, wherein the neighboring region is a first neighboring region and the neighboring profile is a first neighboring profile and the processor is further configured to determine a location of a region boundary of a second neighboring region in a second neighboring profile, wherein the location of the replaced region boundary is determined by using the location of the region boundary of the second neighboring region in the second neighboring profile.

17. The system of claim 11, wherein the selected profile and the neighboring profile are separated by at least one separating profile of the parameter, wherein the separating profile associates at least a separating profile portion of the values with a separating profile distance information from the borehole.

18. The system of claim 11, wherein the values of the parameter are measured by a measurement tool in the borehole and the processor is further configured to define a depth of detection of the measurement tool and remove at least one of the values of the parameter in the initial parameter map based on a comparison of the distance information of the at least one removed value of the parameter and the depth of detection.

19. The system of claim 11, wherein the neighboring profile is calculated by a numeric simulation and the processor is further configured to perform at least one of: (i) selecting the neighboring profile based on a confidence parameter of the numeric simulation; and (ii) selecting the neighboring region based on a thickness of the neighboring region.

20. The system of claim 11, wherein the processor is further configured to steer a drilling assembly through the borehole using the displayed enhanced parameter map.
